(19) United States
(12) Patent Application Publication
(10) Pub. No.: US 2026/0366200 A1
(43) Pub. Date: Nov. 19, 2026

(54) MATERIALS AND METHODS TO MANUFACTURE CARBON FIBERS FROM PETROLEUM ASPHALTENES

(71) Applicant: CarboMat Inc., Calgary (CA)

(72) Inventors: MD Kibria, Calgary (CA); Shabab Saad, Calgary (CA)

(21) Appl. No.: 19/137,563

(22) PCT Filed: Dec. 19, 2023
(86) PCT No.: PCT/CA2023/051706

§ 371 Date: Jun. 10, 2025

Related U.S. Application Data
(60) Provisional application No. 63/433,688, filed on Dec. 19, 2022.

(51) Int. Cl. D01F 9/155; D01D 5/10; D01D 10/02; D01D 13/00; D01F 9/32

(52) U.S. Cl. CPC D01F 9/155; D01D 5/10; D01D 10/02; D01D 13/00; D01F 9/32; D10B 2101/12

(57) ABSTRACT

A method for forming carbon fibers from petroleum asphaltenes comprises providing a common reactor vessel, introducing to the common reactor vessel a quantity of raw asphaltenes, within the common reactor vessel heat treating the raw asphaltenes and melt spinning the heat treated asphaltenes. The method further includes thermosetting the green fibers at a temperature selected to be between 200 and 500 degrees Celsius in air or oxygen to produce stabilized fibers and carbonizing the stabilized fibers under inert atmosphere at a temperature between 1000 and 2000 degrees Celsius to form asphaltene-derived carbon fibers.

### BACKGROUND

### 1. Technical Field

This disclosure relates generally to methods for making carbon fibers from petroleum asphaltenes and uses thereof.

### 2. Description of Related Art

Petroleum asphaltenes are carbonaceous (~70-90% carbon) macromolecules that are extremely heterogeneous in nature and comprise a heavy fraction (15% by weight) of bitumen. Asphaltenes can be amphiphilic in nature depending on the extraction and/or partial upgrading processes. However, most petroleum asphaltenes exhibit hydrophobicity as bulk materials and are insoluble in n-alkane solvents, for which they are considered as strong precursors for carbon fiber (also hydrophobic) manufacturing. Petroleum asphaltenes can exist either in solid or liquid or a combination of both after extraction, or partial upgrading.

### SUMMARY OF THE DISCLOSURE

According to a first embodiment, there is disclosed a method for forming carbon fibers from petroleum asphaltenes comprising providing a common reactor vessel, introducing to the common reactor vessel a quantity of raw asphaltenes, within the common reactor vessel heat treating the raw asphaltenes and melt spinning the heat treated asphaltenes. The method further includes thermosetting the green fibers at a temperature selected to be between 200 and 500 degrees Celsius in air or oxygen to produce stabilized fibers and carbonizing the stabilized fibers under inert atmosphere at a temperature between 1000 and 2000 degrees Celsius to form asphaltene-derived carbon fibers.

The method may further comprise pre-processing the raw asphaltenes to remove selected from the group consisting of sieving, solvent extraction, oxidative desulfurization, mixing with additives, and thermal treatment under shear mixing. The pre-processing may be performed prior to introducing the raw fibers into the common reactor vessel.

The heat treating may occur at a temperature selected to be between 100° C.-400° C. for a duration of 1-15 h under N2 and under shear mixing. The method may further comprise venting volatile substances produced during heat treating. The heat treating may further include mechanically stirring at between 50-500 rpm.

The common reactor vessel may include a melt spinning system selected from the group consisting of a plunger or pneumatically pressurized reactor. The common reactor vessel may further include a spinning box assembly consists of a spinneret, distribution plate, copper cushions, graphene gaskets, and a filtering plate.

According to a first embodiment, there is disclosed a system for forming carbon fibers from petroleum asphaltenes comprising a common reactor vessel including an inlet extending into the common reactor vessel for introducing to the common reactor vessel a quantity of raw asphaltenes, a heat supply for heat treating the raw asphaltenes, a melt spinner for melt spinning the heat treated asphaltenes, means for thermosetting the green fibers to produce stabilized fibers and means for carbonizing the stabilized fibers to form asphaltene-derived carbon fibers.

According to a further embodiment, there is disclosed a method for forming carbon fibers from petroleum asphaltenes comprising receiving a quantity of a raw asphaltenes, passing the raw asphaltenes through a melt spinning system to produce green fibers, immersing the green fibers in a quantity of at least one a substance selected to reduce fiber fusion for an effective period of time, thermosetting the green fibers at a temperature selected to be between 200 and 500 degrees Celsius in air or oxygen to produce stabilized fibers and carbonizing the stabilized fibers under inert atmosphere at a temperature between 1000 and 1800 degrees Celsius to form asphaltene-derived carbon fibers.

The method may further comprise pre-processing the raw asphaltenes to to remove clay, dirt, granules, salts, low molecular weight volatile components, and solvent insoluble particles along with tailoring the melt viscosity of asphaltenes for improved melt extrusion. The pre-processing step may be selected from the group consisting of sieving, solvent extraction, oxidative desulfurization, mixing with additives, and thermal treatment under shear mixing.

Preprocessing may comprise sieving of the raw as the first step thereof. The sieving process of raw asphaltenes may be carried out using a sieve with mesh sizes ranging from 60-120 mesh, which is equivalent to 250 μm-125 μm particle size.

The raw asphaltenes may go through solvent extraction and/or oxidative desulfurization following the sieving process. The solvent extraction may comprise the use of a solvent selected from the group consisting of toluene, dichloromethane, tetrahydrofuran, and mixtures thereof. The solvent extraction may comprise mixing the sieved asphaltenes the solvent in ratio selected to be between 1:5 (w/v) and 1:50 (w/v) asphaltene to solvent ratio. The mixture may be stirred by a stirrer until a homogeneous solution is formed followed by vacuum filtration. The stirrer may be selected from the group consisting of a manual and a manual, magnetic or automated stirrer. In the vacuum filtration, the solvent-insoluble particles are left on the filter paper and the asphaltenes dissolved in the solvent are passed therethrough. The filtrate may be heated to between 50° C.-250° C. under continuous stirring at a speed of between 100 and 2000 rpm for a period of time from between 2 and 24 hours. Once all the solvent has evaporated, the solid asphaltenes may be dried in a drier. The drier may comprise a vacuum dryer selected to have a temperature between 50 and 70° C. for a period of time between 2 and 12 hours.

The oxidative desulfurization may be performed at a temperature of between 40 and 70° C. to chemically oxidize the raw asphaltenes. The oxidized raw asphaltenes may have sulfur extracted therefrom after oxidization. The oxidative desulfurization may comprise mixing the raw asphaltenes with hydrogen peroxide for a first period of time, mixing the raw asphaltenes and hydrogen peroxide with sodium hydroxide, and allowed to settle for a second period of time.

The hydrogen peroxide may comprise a 20 to 80% (v/v) hydrogen peroxide solution. The hydrogen peroxide may be mixed in a ratio of between 1:10 to 1:80 (w/v) asphaltene to hydrogen peroxide ratio. The first time may be selected to be between 1 and 10 hours under continuous stirring at between 40 and 80° C. under 200-2000 rpm. The sodium hydroxide may comprise a 10-50% (w/v) saturated sodium hydroxide solution. The sodium hydroxide may be added to the raw asphaltene and Hydrogen peroxide mixture in a ratio of between 1:10 and 1:80 (w/v) raw asphaltene to sodium hydroxide to produce a second mixture. The second mixture may be continuously stirred at a temperature of between 30 and 100° C. under 100-1000 rpm until the reaction is complete. The second period of time may selected to be between 1 and 12 hours.

The phase separated solvent may be removed using a separation filter followed by washing with deionized water at least 5-10 times before the solid phase is vacuum filtrated to obtain desulfurized asphaltenes.

The solvent extracted asphaltenes may be dry mixed with additives selected from the group consisting of 1-30% by weight. The dry mixing may be followed by polymerization and mixing of polymer-asphaltene blend at temperatures of between 100 and 350° C. under high shear for between ½ and 15 hours.

The raw asphaltenes after undergoing solvent extraction, and/or oxidative desulfurization, and/or additive incorporation, and/or dry mixing with additives may go through a thermal treatment at temperatures between 100 and 400° C. for a duration of 1 to 15 hours under N2 and under shear mixing.

The pre-processed asphaltenes may undergo thermal treatment under nitrogen at a pressure of between 10 and 200 kPa with a an exhaust valve allowing volatile species to exit the system. The pre-processed may asphaltenes undergoing thermal treatment by mechanically stirring in a reactor at between 50 and 500 rpm for uniform mixing and to improve mesophase content.

The melt spinning system may comprise a plunger or pneumatically pressurized reactor to produce green fibers at various winding rates. The spinning box assembly may consist of a spinneret, distribution plate, copper cushions, graphene gaskets, and a filtering plate. The spinneret may have an orifice diameter selected to be between 100 and 300 μm along with an orifice of length to diameter ratio of 1-5 in the spinneret.

The spinneret may have between 1 and 120 orifices for multiple filament drawing. The pre-treated asphaltenes may be spun at spinning temperatures selected to be between 160 and 350° C. under nitrogen pressures of between 50 and 2000 kPa with or without shear mixer at 20-500 rpm.

The pre-treated asphaltenes may be spun with winding rates ranging from 50 to 4000 rpm to produce green fibers of diameters 5-300 μm.

According to a further embodiment, there is disclosed a method for forming carbon fibers from petroleum asphaltenes comprising heat treating the raw asphaltenes, melt spinning the heat treated asphaltenes to produce green fibers, immersing the green fibers in an intermediate chamber containing a quantity of at least one anti fusion substance selected to reduce fiber fusion for an effective period of time, thermosetting the green fibers at a temperature selected to be between 200 and 500 degrees Celsius in air or oxygen to produce stabilized fibers and carbonizing the stabilized fibers under inert atmosphere at a temperature between 1000 and 2000 degrees Celsius to form asphaltene-derived carbon fibers.

The intermediate treatment chamber may comprise a vessel having organic and inorganic acids, plasma chamber, glass chambers, iodine crystals, shelves, or rollers to hold asphaltene-derived green fibers, and support to keep the green fibers fully immersed. The asphaltene-derived green fibers may completely immersed in the anti fusion substance within the intermediate treatment chamber. The anti fusion substance may be provided in a concentration of between 5-60%. The anti-fusion substance may be selected from the group consisting of nitric acid, sulfuric acid, hydrochloric acid, phosphoric acid, and acetic acid. The green fibers may be soaked in the intermediate chamber for between 5 and 120 minutes.

The asphaltene-derived green fibers may be placed inside a glass quartz tube within the intermediate chamber connected to a vacuum supply containing a quantity of iodine crystals for iodization of the green fiber. The quantity of iodine may be between 100 m and 100 g. The greenfibers and iodine may be heated to between 80 and 120 degrees C. The acid treated and/or iodine treated asphaltene-derived green fibers may be dried.

The asphaltene-derived acid treated and/or I2 treated fibers may undergo plasma treatment under oxygen to increase surface roughness and surface oxygen concentration of the fibers to avoid fiber fusion and reduce stabilization time. The oxygen may be provided at a pressure of between 0.1-1 torr. The plasma treatment may include radio frequency at power levels of 7 W-30 W (1 MHz-14 MHz) for 5-120 mins.

According to a further embodiment, there is disclosed a method for forming carbon fibers from petroleum asphaltenes comprising heat treating the raw asphaltenes, melt spinning the heat treated asphaltenes to produce green fibers, thermosetting the green fibers at a temperature selected to be between 200 and 500 degrees Celsius in air or oxygen to produce stabilized fibers and carbonizing the stabilized fibers under inert atmosphere at a temperature between 1000 and 2000 degrees Celsius to form asphaltene-derived carbon fibers.

The oxidative stabilization process may comprise a multi-step stabilization in air or oxygen because of the heterogeneous nature of the precursor material. The green fibers may undergo air or oxygen stabilization at 200 to 260° C. for between 0.5-5 hours followed by 300° C.-400° C. for 10-120 mins. The green fibers may undergo multi-step stabilization in air or oxygen with a temperature ramp rate of 0.5-1° C./min from 25° C. to 260° C. followed by a temperature ramp rate of 3-5° C./min from 260° C. to 350° C.

The carbonization process may comprise using a multi-step carbonization process up to 2000° C. either under tension or under no tension. The stabilized fibers may be carbonized at temperatures of between 400 and 800° C. for 10-30 minutes followed by 1500° C. for 1-5 h and 1700° C. for 1-120 mins.

The stabilized fibers may follow a multi-step carbonization process including a low-temperature carbonization at between 400 and 800° C. The carbon fibers may undergo surface treatments for development of carbon fiber reinforced thermoplastic composites. The surface treatments may be selected from the group consisting of acid oxidation, plasma treatment, silane treatment and sizing.

Other aspects and features of the present disclosure will become apparent to those ordinarily skilled in the art upon review of the following description of specific embodiments in conjunction with the accompanying figures.

### DETAILED DESCRIPTION

Aspects of the present disclosure are now described with reference to exemplary methods and systems. In particular, the present method provides an end-to-end process for the production of carbon fibers from petroleum asphaltenes including a series of steps including pre-processing, melt spinning, intermediate treatments, oxidative stabilization, and high-temperature carbonization. This disclosure will elaborate on all the details of each of these steps that are important for developing asphaltene-derived carbon fibers. In particular, the present disclosure provides a method and system for forming carbon fibers from petroleum asphaltenes. The method comprises receiving a quantity of a raw asphaltenes, passing the raw asphaltenes through a melt spinning system to produce green fibers, immersing the green fibers in an intermediate chamber containing a quantity of at least one a substance selected to reduce fiber fusion for an effective period of time, thermosetting the green fibers received from the intermediate chamber at a temperature selected to be between 200 and 500 degrees Celsius in air or oxygen to produce stabilized fibers and carbonizing the stabilized fibers under inert atmosphere at a temperature selected to be between 1000 and 1800 degrees Celsius to form asphaltene-derived carbon fibers. In particular, in some embodiments, the process may include performing heat treating and melt spinning of the asphaltenes within a common vessel so as to prevent cooling of the asphaltenes therebetween.

Pre-processing may be important for the purification of raw asphaltenes to make them suitable for the spinning process. Pre-processing of raw asphaltenes is useful to remove impurities like clay, dirt, sand, granules, salts, sulfur, heavy metals, low molecular weight volatiles, and any other type of suspending materials that can disrupt the melt and extrusion properties of raw asphaltenes. In this disclosure, raw asphaltenes refer to the heavy fraction of the bitumen, which can be extracted via a number of processes, including partial upgrading, solvent extraction etc. Pre-processing removes clay, dirt, granules, salts, low molecular weight volatile components, and solvent insoluble particles along with tailoring the melt viscosity of asphaltenes for improved melt extrusion, which is comprised of: sieving, solvent extraction, oxidative desulfurization, mixing with additives (e.g., polymers), and thermal treatment under shear mixing.

In some embodiments, sieving of raw asphaltenes is the first step in the pre-processing technique. The sieving process of raw asphaltenes may be carried out using a sieve with mesh sizes ranging from 60-120 mesh, which is equivalent to 250 μm-125 μm particle size. Sieving may reduce the amount of clay, dirt, granules, and large coagulants in the raw asphaltenes that can disrupt the melt extrusion. In some embodiments, the raw asphaltenes can go through solvent extraction and/or oxidative desulfurization following the sieving process.

In some embodiments, the raw asphaltenes may go through solvent extraction with toluene, dichloromethane, tetrahydrofuran, etc., and mixtures thereof, to remove solvent insoluble particles that can disrupt the melt extrusion. In this embodiment, sieved asphaltenes may be mixed with either toluene, dichloromethane, tetrahydrofuran, or any other similar non-polar solvents or mixtures thereof, in a 1:5 (w/v), 1:10 (w/v), 1:15 (w/v), 1:20 (w/v), 1:30 (w/v), 1:40 (w/v), 1:50 (w/v) asphaltene to solvent ratio. The mixture may be stirred manually or under a magnetic/automated stirrer until a homogeneous solution is formed followed by vacuum filtration. In this embodiment, the solvent-insoluble particles may be left on the filter paper and the asphaltenes dissolved in the solvent are passed through the filter. The filtrate may be then heated from 50° C.-250° C. (depending on the boiling point of the solvent) under continuous stirring (100-2000 rpm) overnight for 2-24 h. Once all the solvent has evaporated, the solid asphaltenes may be dried in a vacuum dryer at 50-70° C. overnight for 2-12 h. The yield of solvent extraction varies from 20%-99% depending on the material volume and solvent used.

In some embodiments, the raw asphaltenes may go through oxidative desulfurization which can remove up to 70% sulfur from raw asphaltenes. Most of the sulfur in raw asphaltenes are present as thiophenes for which they (thiophenes and other forms of sulfur) are cleaved out from the asphaltene macromolecular structure. The oxidative desulfurization is a chemical process in low temperature (~40-70° C.) where raw asphaltenes are chemically oxidized first followed by sulfur extraction.

In some embodiments, the raw asphaltenes are mixed in a 20-80% (v/V) H2O2 (hydrogen peroxide) solution in a 1:10 (w/v), 1:20 (w/v), 1:30 (w/v), 1:40 (w/v), 1:50 (w/v), 1:60 (w/v), 1:70 (w/v), 1:80 (w/v) asphaltene to H2O2 ratio. The mixture is mixed for 1-10 h under continuous stirring at ~40-80° C. under 200-2000 rpm. After that, 10-50% (w/v) saturated NaOH is added to the asphaltene-H2O2 mixture in a 1:10 (w/v), 1:20 (w/v), 1:30 (w/v), 1:40 (w/V), 1:50 (w/v), 1:60 (w/v), 1:70 (w/v), 1:80 (w/v) asphaltene to NaOH ratio. The final mixture is then continuously stirred at ~30-100° C. under 100-1000 rpm. Once the reaction is complete, the mixture is allowed to settle for 1-12 h depending on the volume scale (e.g., a 200 mL mixture needs 30 mins whereas a 1 L mixture could take 6-12 h) for phase separation.

In some embodiments, the phase separated solvent may be removed using a separation filter followed by washing with deionized water at least 5-10 times before the solid phase is vacuum filtrated to obtain desulfurized asphaltenes. The oxidative desulfurization (two different reactions) may cause the sulfur present as thiophenes in asphaltenes to be initially oxidized to form sulfones (O=S=O) which are more polar than thiophenes thus allowing them to dissolve in a polar phase. Once thiophenes are oxidized to sulfones, a strong base such as NaOH (sodium hydroxide) extracts the sulfones from the asphaltenes thus leading to a decreased sulfur content. The super-peroxide formed during the reaction of NaOH and H2O2 further oxidizes the sulfur in thiophenes to sulfones.

In some embodiments, solvent extracted asphaltenes may be first dry mixed with hydrophobic extrusion grade polymers/elastomers/additives (e.g., polystyrene, high impact polystyrene, styrene-ethylene-butylene-styrene, polypropylene, polyester, polymethyl methacrylate, polycarbonate, etc.) with varying concentrations of 1-30% by weight. The dry mixing of additive/polymer/elastomer may be followed by polymerization and mixing of polymer-asphaltene blend at temperatures of ~100-350° C. (depending on the glass transition temperature of the polymer/elastomer/additive) under high shear for 0.5-15 h. This melt-mixing induces polymerization and cross-linking of the molecular chains between the additive/polymer/elastomer and the asphaltenes.

The dry mixing or wet mixing (or a combination of both) and thermal polymerization of the modified (with additive/polymer/elastomer) asphaltenes exhibit reduced or increased melt viscosities and improved melt spinning characteristics.

In some embodiments, the raw asphaltenes may undergo physical or chemical pre-processing techniques go through a modified version of thermal treatment/mixing afterward that is directly connected to the melt extrusion system. The raw asphaltenes may after undergoing solvent extraction, and/or oxidative desulfurization, and/or additive incorporation, and/or dry mixing with additives go through a thermal treatment at temperatures between 100° C.-400° C. for a duration of 1-15 h under N2 and under shear mixing. The raw asphaltenes may undergo thermal treatment to eliminate low molecular weight volatile components that can increase the thermal stability, mesophase content (10-70%) and softening point of asphaltenes. The thermal treatment induces polycondensation and evolution of volatile species such as CH4, CO2, C2H6, CH2O, NO, H2S, H2, H2O, etc. that need to be vented out during the whole process.

The pre-processed asphaltenes may undergo thermal treatment at low N2 pressure (~10-200 kPa) with a partially open exhaust valve, thus allowing the volatile species to exit the system. The presence of volatile species during melt spinning induces voids and defects in the green fiber microstructures. In some embodiments, the pre-processed asphaltenes undergoing thermal will be carried out in the same reactor vessel. In particular, this is to avoid Cooling down the thermally treated asphaltenes during transfer to a separate reactor under ambient conditions and melting them again in the melt spinning machine which may destroys the suitable rheological properties (e.g., shear viscosity) needed for a continuous spinning system. The pre-processed (after solvent extraction or oxidative desulfurization or polymerization with additives, polymers, elastomers, etc.). asphaltenes undergoing thermal treatment are mechanically stirred in a reactor at 50-500 rpm for uniform mixing and to improve mesophase content.

The melt spinning system for spinning pre-treated asphaltenes which may or may not be pre-treated as set out above comprises either a plunger or pneumatically pressurized reactor to produce green fibers at various winding rates.

In particular, the spinning box assembly may consist of a spinneret, distribution plate, copper cushions, graphene gaskets, and a filtering plate. The spinneret has an orifice diameter of 100 μm, 150 μm, 200 μm, 250 μm, or 300 μm along with an orifice of L/D ratio of 1-5 in the spinneret. The spinneret may have between 1 and 120 orifices for multiple filament drawing.

The pre-treated or raw asphaltenes may be spun at elevated spinning temperatures ranging from 160° C.-350° C., depending on the softening point of the material, under N2 pressures of 50-2000 kPa with/without shear mixer at 20-500 rpm. The pre-treated or raw asphaltenes spun with winding rates ranging from 50-4000 rpm to produce green fibers of diameters 5-300 μm following the required combination of spinning temperature, spinning pressure and spinneret size.

According to some embodiments, the melt spinning system produces green fibers of average diameter 10-20 μm continuously using 150-300 μm spinneret orifice at a spinning temperature of 200-350° C. and spinning pressure of 400-800 kPa, after thermal treatment at 200-300° C. for 0.5-3 h with a winding rate of 1500-2700 rpm. According to some embodiments, the melt spinning system may produce green fibers of average diameter 10-15 μm continuously using 150-300 μm spinneret orifice at spinning temperatures of 200-400° C. and spinning pressure of 400-2000 kPa, after polymerization under thermal treatment at 150-300° C. for 1-5 h with a winding rate of 1500-3000 rpm.

The melt spinning system with a spinneret with multiple orifices (>1) may be used to produce multiple filaments of green fibers which are winded altogether through a cycloid. The melt spinning of green fibers may be unstable and non-continuous with multiple filament breaks for thermal treatment at higher spinning temperatures (>280° C.) for longer times (>3 h).

In some embodiments, the green fibers are transferred to an intermediate treatment chamber for treatment with a prevent fusion between the fibers. In particular, the intermediate treatment chamber may comprise a large Teflon based bath, organic and inorganic acids, plasma chamber, glass chambers, iodine crystals, shelves, or rollers to hold asphaltene-derived green fibers, and support to keep the green fibers fully immersed. It will be appreciated that the use of an intermediate treatment chamber may be performed with or without the use of a common treatment chamber for heat treatment and melt spinning as well as other embodiments as discussed below.

In some embodiments, the asphaltene-derived green fibers are completely immersed in 5-60% HNO3, H2SO4, HCl, HNO2, H3PO4, CH3COOH, or any combination of those or any similar class of acids (binary, oxy, etc.) for 5-120 mins for surface functionalization and nitration.

In some embodiments, the asphaltene-derived green fibers are placed inside a glass quartz tube connected to a vacuum supply containing 100 mg-100 g of iodine (I2) crystals and heated to 80-120° C. to form sublimed I2 vapors for iodization of green fibers leading to a 100-200% mass uptake of green fibers. It will be appreciated that in some embodiments, the acid treatment and/or iodine treatment of asphaltene-derived green fibers may be necessary to reduce fiber fusion during oxidative stabilization.

In particular, the acid or I2 molecules may act as a surface modifier between individual fibers in a fiber bundle. For example, nitric acid and iodine treatment results in increased nitrogen and iodine content of 3-15% and 5-30%, respectively. The I2 treatment enables pre-iodization (or thermo-setting) of the carbon fiber surface which helps to avoid fiber fusion in the subsequent stabilization process.

In some embodiments, the acid treated and/or I2 treated asphaltene-derived green fibers may be dried out of excess acid and set aside to air dry for 10-60 mins before placing them in the stabilization furnace. The asphaltene-derived acid treated and/or I2 treated fibers undergo plasma treatment under O2 with a pressure of 0.1-1 torr and radio frequency power levels of 7 W-30 W (1 MHz-14 MHz) for 5-120 mins which increases surface roughness and surface oxygen concentration (e.g., 10-60 atomic %) of the fibers to avoid fiber fusion and reduce stabilization time by 30-80%. The plasma treatment enables pre-oxidation (or thermo-setting) of the carbon fiber surface which helps to avoid fiber fusion in the subsequent stabilization process.

The oxidative stabilization process comprises exposing the acid-treated and/or I2 treated and/or plasma-treated green fibers in air or O2 at temperatures (~200-500° C.) for thermosetting and avoid melting during high-temperature carbonization processes.

In some embodiments, the acid-treated and/or I2 treated, or plasma-treated green fibers may undergo a multi-step stabilization in air or O2 because of the heterogeneous nature of the precursor material. In some embodiments, the acid-treated and/or I2 treated, or plasma-treated green fibers may undergo air or O2 stabilization at 200° C.-260° C. for 0.5-5 hours followed by 300° C.- 400° C. for 10-120 mins.

In some embodiments, the acid-treated and/or I2 treated asphaltene-derived green fibers may undergo multi-step stabilization in air or O2 with a temperature ramp rate of 0.5-1° C./min from 25° C. to 260° C. followed by a temperature ramp rate of 3-5° C./min from 260° C. to 350° C. In some embodiments, the acid-treated and/or I2 treated and/or plasma-treated green fibers may follow an initial slow temperature ramp rate because of the lower softening point of asphaltenes. The first stabilization temperature for acid-treated and/or I2 treated and/or plasma-treated green fibers is chosen based on the spinning temperature (usually 10-50° C. higher than first stabilization temperature) of the precursor material.

In some embodiments, the acid-treated and/or I2 treated asphaltene-derived green fibers may undergo extensive oxidation and cross-linking reactions including polymerization of small molecules to form larger molecules, creation of active sites by oxidizing off alkyl carbons, formation of carbonyl and phenoxy functional groupings, etc. thus increasing the melting point of the fibers well above the higher carbonization temperatures. In some embodiments, the acid-treated and/or I2 treated asphaltene-derived green fibers may undergo multi-step stabilization in air or O2 through which the bulk oxygen concentration within the fibers increases from 2-5% to 20-40%.

The high-temperature carbonization process comprises exposing the asphaltene-derived stabilized fibers to high temperatures under inert atmosphere (N2 or Ar flow) to form asphaltene-derived carbon fibers. In some embodiments, the asphaltene-derived stabilized fibers are carbonized using a multi-step carbonization process up to 1800° C. either under tension or under no tension.

In some embodiments, the asphaltene-derived stabilized fibers may be carbonized at 400° C.-800° C. for 10-30 minutes followed by 1500° C. for 1-5 h and 1700° C. for 1-120 mins.

In some embodiments, the asphaltene-derived stabilized fibers may follow a multi-step carbonization process where low-temperature carbonization at 400-800° C. helps to avoid the disruption of fiber microstructures due to the evolution of multiple volatile species like CH4, H2, etc. below 1000° C. In some embodiments, the asphaltene-derived stabilized fibers may undergo high-temperature carbonization to remove the non-carbon elements (e.g., N, O, H, S, etc.) in the stabilized fibers as low molecular weight volatile species.

The asphaltene-derived carbon fibers may exhibit 85-98% carbon content following carbonization at 1100-1700° C. for 1-6 h. The sulfur content of asphaltene-derived carbon fibers is reduced by 70-90% with increased carbonization time (2-3 h) at 1500° C.-1700° C. The asphaltene-derived carbon fibers may have average diameter of 3-10 μm with no surface or microstructural defects following carbonization at 400-1700° C. for 0.5-6 h. The asphaltene-derived single carbon fibers may exhibit tensile strengths of 900-3000 MPa and elastic modulus of 30-250 GPa following carbonization at 400° C.-1700° C. for 10 mins to 6 h. The asphaltene-derived carbon fibers may undergo surface treatments (e.g., acid oxidation, plasma treatment, silane treatment, sizing, etc.) for development of carbon fiber reinforced thermoplastic composites. It will be appreciated that the use of a multi step stabilization or carbonization process may be used in conjunction with or without the use of a common treatment chamber for heat treatment and melt spinning as well as other embodiments or the use of intermediate treatment chamber for reducing fiber fusion. It will also be appreciated that each of the multi step stabilization and/or carbonization may be used together or separately.

While specific embodiments have been described and illustrated, such embodiments should be considered illustrative only and not as limiting the disclosure as construed in accordance with the accompanying claims.

What is claimed is:

1. A method for forming carbon fibers from petroleum asphaltenes comprising:
providing a common reactor vessel;
introducing to the common reactor vessel a quantity of raw asphaltenes;
within the common reactor vessel:
heat treating the raw asphaltenes; and
melt spinning the heat treated asphaltenes;
thermosetting the green fibers at a temperature selected to be between 200 and 500 degrees Celsius in air or oxygen to produce stabilized fibers; and
carbonizing the stabilized fibers under inert atmosphere at a temperature between 1000 and 2000 degrees Celsius to form asphaltene-derived carbon fibers.

2. The method of claim 1 further comprising pre-processing the raw asphaltenes to remove selected from the group consisting of sieving, solvent extraction, oxidative desulfurization, mixing with additives, and thermal treatment under shear mixing.

3. The method of claim 2 wherein the pre-processing is performed prior to introducing the raw fibers into the common reactor vessel.

4. The method of claim 1 wherein heat treating occurs at a temperature selected to be between 100° C.-400° C. for a duration of 1-15 h under N2 and under shear mixing.

5. The method of claim 4 further comprising venting volatile substances produced during heat treating.

6. The method of any one of claims 4 through 5 wherein heat treating further includes mechanically stirring at between 50-500 rpm.

7. The method of any one of claims 4 through 6 wherein the common reactor vessel includes a melt spinning system selected from the group consisting of a plunger or pneumatically pressurized reactor.

8. The method of any one of claims 4 through 7 wherein the common reactor vessel further includes a spinning box assembly consists of a spinneret, distribution plate, copper cushions, graphene gaskets, and a filtering plate.

9. A system for forming carbon fibers from petroleum asphaltenes comprising a common reactor vessel including:
an inlet extending into the common reactor vessel for introducing to the common reactor vessel a quantity of raw asphaltenes;
a heat supply for heat treating the raw asphaltenes;
a melt spinner for melt spinning the heat treated asphaltenes;
means for thermosetting the green fibers to produce stabilized fibers; and
means for carbonizing the stabilized fibers to form asphaltene-derived carbon fibers.
